(19) United States
(12) Patent Application Publication
(10) Pub. No.: US 2015/0320057 A1
(43) Pub. Date: Nov. 12, 2015

(54) BAKE STABLE FILLING CONTAINING MICROPARTICLES

(71) Applicants: Alice S. CHA, (US); Albert A. HONG, Kildeer, IL (US); Alicia M. OMANS, Jersey City, NJ (US)

(72) Inventors: Alice S. CHA, Glenview, IL (US); Albert A. HONG, Deerfield, IL (US); Alicia M. OMANS, East Hanover, NJ (US)

(73) Assignee: Intercontinental Great Brands LLC, East Hanover, NJ (US)

(21) Appl. No.: 14/648,542

(22) PCT Filed: Dec. 4, 2013
(86) PCT No.: PCT/US13/73040

§ 371 Date: May 29, 2015

Related U.S. Application Data
(60) Provisional application No. 61/733,682, filed on Dec. 5, 2012.

(51) Int. Cl. A21D 13/00

(52) U.S. Cl. CPC A21D 13/0041; A21D 13/0022

(57) ABSTRACT

A creamy-textured, bake stable filling including: a liquid component and at least about 1 wt % microparticles, wherein the particle size of the microparticles is less than about 8 microns; and wherein the liquid component includes microparticles in an amount of about 1 wt % to about 30 wt % of the liquid component.

### CROSS-REFERENCE TO RELATED APPLICATIONS

This application claims the benefit of U.S. Provisional Patent Application No. 61/733,682 filed Dec. 5, 2012 entitled “Bake Stable Filling Containing Microparticles”, which is incorporated by reference herein in its entirety.

### BACKGROUND OF THE INVENTION

The present invention generally relates to compositions and methods for an intermediate moisture bake-stable filling containing microparticles.

### BRIEF SUMMARY OF THE INVENTION

According to some embodiments of the present invention, a bake stable filling includes a liquid component and microparticles having a particle size of less than about 8 microns. In some embodiments, the liquid component includes microparticles in an amount of about 1 wt % to about 30 wt % of the liquid component; or of about 2 wt % to about 25 wt % of the liquid component. In some embodiments, the filling includes a ratio of microparticles to moisture of about 1:60 to about 1:4. The microparticles may include fibers, cellulose such as microcrystalline cellulose, protein such as whey protein, water insoluble food materials, or a combination thereof.

In some embodiments, the filling includes the liquid component in an amount of about 20 wt % to about 50 wt % of the filling. In certain embodiments, the liquid component includes a polyhydric alcohol.

In certain embodiments, the filling has a water activity of about 0.5 to about 0.86; includes less than 30 wt % fat; has a shelf life of at least about 3 months; and may contain no starch.

In some embodiments, the filling exhibits substantially no filling spread, or a spread of less than about 1 cm, in a radial direction beyond an original sample size when 20 c.c. (+/−2 c.c.) of the filler is placed on filter paper and exposed to a temperature of about 150° C. for about 10 minutes.

In some embodiments, a composite product includes the filling and a baked good.

According to some embodiments of the present invention, a method of preparing a bake stable filling includes, providing ingredients for a liquid component; providing microparticles having a particle size of less than about 8 microns; providing any additional components; mixing at least the ingredients for the liquid component and the microparticles to provide a homogenous blend; and homogenizing the blend to provide a filling having a liquid component and at least 1 wt % microparticles, wherein the liquid component includes microparticles in an amount of about 1 wt % to about 30 wt % of the liquid component. In some embodiments, the method includes passing the blend through a bead mill.

The foregoing summary, as well as the following detailed description of certain embodiments of the food product will be better understood when read in conjunction with the following exemplary embodiments and the drawing.

### BRIEF DESCRIPTION OF THE SEVERAL VIEWS OF THE DRAWINGS

FIG. 1 shows light microscopy images of one embodiment of this invention.

FIG. 2 shows particle size distribution of one embodiment of this invention.

### DETAILED DESCRIPTION OF THE INVENTION

Methods and compositions of the present invention relate to bake stable fillings which may sustain baking and extrusion processes with little or no liquid separation and minimum spread of fillings, and which may provide a creamy texture and mouthfeel in the finished product. Fillings of the present invention may be sweet or savory.

In some embodiments, fillings of the present invention are shelf-stable. In some embodiments, fillings of the present invention are shelf stable at ambient temperature for up to 1 year; up to 6 months; up to 3 months; or up to 1 month.

As used herein, “bake stable” is understood to mean that the filling is resistant to degradation and exhibits substantially no spread and substantially no oiling off when exposed to baking temperatures of about 150° C.±5° C. for about 10 minutes. Because fillings may be partially insulated from actual baking temperatures by surrounding dough, a filling which is stable to a given temperature, such as 150° C., is suitable for use in a composite filled dough product which may be subjected to substantially higher cooking temperatures than 150° C.

Fillings which lack stability at a given temperature may become hard, dry, may oil out, may spread and perhaps become blown out from enclosed casing. Blown out fillers may brown significantly which may be partially the result of browning reactions between proteins and reducing sugars, or thermal degradation of sugars, such as lactose. An objective measure of hardening is the change in viscosity which a filling composition may undergo upon exposure to heat. While some increase in filling viscosity is acceptable, dramatic, e.g., ten-fold or more increases, are clear indicia of poor bake stability.

One simple screening test for bake stability in fillings involves observing the extent at which the filling spreads and oils off on a sheet when heated at a given temperature and time. If the spread test is conducted with the filling placed on a filter paper, the extent of “oiling off” may also be observed. Oiling off results in a ring of oil on the paper which will extend beyond the extent of the spread of the filler composition. Oiling off may be measured from the edges of the filing after it has been baked and may have expanded, versus the pre-baked filling position. Minimal spread and oil off are indicia of good bake stability. For example, one can place about 20 c.c. (+/−2 c.c.) of filler composition in a semi-spherical shape on a filter paper (such as Whatman #1 filler paper or equivalent) and expose the filler to about 150° C. for about 10 minutes. In some embodiments of the present invention, under such conditions the filling will exhibit substantially no filling spread; filling spread less than 1 cm beyond the outer edge of the original sample in a radial direction; less than about 0.8 cm beyond the outer edge of the original sample in a radial direction; or less than about 0.5 cm beyond the outer edge of the original sample in a radial direction. In some embodiments of the present invention, under such conditions the filling will exhibit substantially no oiling off; less than about 1 cm beyond the outer edge of the heated filling in a radial direction; less than about 0.8 cm beyond the outer edge of the heated filling in a radial direction; or less than about 0.5 cm beyond the outer edge of the heated filling in a radial direction.

In some embodiments, the filling includes a liquid continuous phase and a discontinuous phase. In some embodiments, the liquid continuous phase includes a liquid component and soluble solids. The liquid component can include, but not be limited to, water, moisture from ingredients, and plasticizing polyhydric alcohols such as glycerol or propylene glycol. The discontinuous phase can include, but not be limited to, emulsified fat, and insoluble materials including microparticles.

In some embodiments, the filling contains microparticles which may contribute to the creamy texture and mouthfeel, and to bake stability. Microparticles may be part of a discontinuous phase of the filling and are suspended in the liquid continuous phase, and will be described in more detail herein.

In some embodiments, the filling contains no starch. Starch could compete with other soluble solids for hydration in a limited-water environment, and could increase the product viscosity significantly thereby making processing more difficult. In addition, the viscosity of a starch system may be sensitive to baking temperature which could cause the filler to spread significantly during baking. In one embodiment, the filling contains less than about 10% fat. In another embodiment, the filling contains less than about 20% fat. In another embodiment, the filling contains less than about 30% fat. Preferably, fat should be present in the emulsion to minimize the tendency for oiling off during baking or storage.

In some embodiments, fillings are added to a dough prior to baking to create a composite filled dough product. For example, fillings may be included between two layers of dough in a sandwich formation, as a filling completely enclosed by the dough, or as a layer on top of the dough. In some embodiments, the fillings are added to baked goods after baking.

Liquid Continuous Phase

The liquid continuous phase can include, but not be limited to, a liquid component and other soluble materials. Fillings of the present invention may include a liquid component which may include water, moisture from added ingredients, and water miscible liquid, such as polyhydric alcohols. In some embodiments, fillings may include a liquid component in an amount of at least about 20 wt % to about 60 wt % of the filling; or about 25 wt % to about 50 wt % filling. In one embodiment, the liquid component may comprise a plasticizing polyhydric alcohol in an amount of at least about 10 wt %, at least about 15 wt %, or at least about 25 wt % of the liquid component.

To aid in obtaining the desired soft, creamy texture and to provide a controlled water activity in the product, in some embodiments a plasticizing polyhydric alcohol is employed at a level of at least about 2 wt % up to about 20 wt % of the filling; or about 4 wt % to about 15 wt % of the filling. Suitable plasticizing agents may include liquid, edible di-, or tri-hydric alcohols or sugar alcohols or other polyhydric alcohols of suitable flavor and effective for this purpose. Prominent among these are glycerol and propylene glycol, but others of this class and mixtures of these can be employed.

In addition to the plasticizing polyhydric alcohol, the liquid continuous phase may also contain sufficient other dissolved water-soluble materials capable of reducing water activity and arresting microbial growth in the composition. Suitable soluble materials may include non-sweet carbohydrates such as polydextrose and maltodextrin, and salts such as sodium chloride, sodium citrate, etc. Other soluble materials may include sweet carbohydrate such as high fructose corn syrup, corn syrup solids, and fructose syrup, glucose syrup, etc.

In some embodiments, the combined amount of the polyols and the dissolved soluble solids in a filling will be sufficient to provide the total filling with a desired water activity (“A_{w}”). In some embodiments, the filling has an intermediate water activity. In some embodiments, the filling has a water activity of about 0.3 to about 0.9; about 0.4 to about 0.87; about 0.5 to about 0.86; about 0.6 to about 0.83; about 0.7 to about 0.82; about 0.3; about 0.4; about 0.5; about 0.6; about 0.7; about 0.8; about 0.82; about 0.83; about 0.86; or about 0.9. The water activity of the filling may be an important factor in maintenance of both microbiological and textural stability of the filling and any composite it is used to make.

In some embodiments, the filling exhibits yield stress sufficient to prevent the spread or ooze out of fillers before, during and after baking. While not wishing to be bound by theory, the yield stress of a filling may be primarily dominated by a ratio of microparticles to moisture in the liquid component. The yield stress of the product should be greater than about 100 Pa; greater than about 500 Pa; greater than about 1000 Pa; greater than about 1500 Pa; greater than about 2000 Pa; greater than about 2500 Pa; greater than about 3000 Pa; or within the range of from about 100 Pa to about 3500 Pa; as measured by a Haake Viscotester, Model 550 at 25° C. using four bladed 16×6 mm vane fixture at 0.1 rpm. Fillings of some embodiments of the present invention may include any additional suitable ingredients, including emulsifiers, stabilizers, flavoring ingredients, and/or humectants in an effective amount to provide a desired water activity, flavor, and consistency of the filling.

In some cases, a flavor modifier such as any of those mentioned in U.S. Pat. No. 5,641,795 can be employed in minor amounts, such as up to about 2.0 wt % of the filling or from about 0.5 wt % to about 1.0 wt % of the filling, to suppress any undesired sweetness provided by glycerol, propylene glycol or the like. One such product comprises a lactisole powder (1% lactisole) and is sold under the trademark Super Envision by Domino Sugar.

Discontinuous Phase

A filling may also include a discontinuous phase, including undissolved solids. In some embodiments, the filling includes a savory flavor, such as dehydrated cheese powder. In certain embodiments, the filling may include a dehydrated cheese powder in an amount of about 5 wt % to about 50 wt % of the filling; about 10 wt % to about 45 wt % of the filling; about 15 wt % to about 40 wt % of the filling; about 20 wt % to about 35 wt % of the filling; about 5% of filling; about 10 wt % of the filling; about 15 wt % of the filling; about 20 wt % of the filling; about 25 wt % of the filling; about 30 wt % of the filling; about 35 wt % of the filling; about 40 wt % of the filling; about 45 wt % of the filling; or about 50 wt % of the filling. Suitable dehydrated cheese powder may especially include flavorful cheese such as cheddar cheese or cream cheese, which might be blended with such optional ingredients such as cream, salt, sodium phosphate and lactic acid. Such a product with approximately a 50% fat content is available, for example, from Kraft Food Ingredients under the brand name CheezTang. Other flavor enhancers such as liquid flavor concentrate, monosodium glutamate, yeast extracts, lactic acid, etc. can also be used to improve flavor profile.

The flavor of fillers is preferably principally provided by the flavor in dehydrated or concentrated form. For example, in the case of cheese, the flavor should come principally from a suitable cheese flavor ingredient, such as cheese powder flavor, that is substantially insoluble in the aqueous liquid phase. Suitable for use as the cheese ingredient other than materials that may be referred to as cheese powders flavors are cheese products having a suitably small particle size and substantially equivalent properties and flavor. In some embodiments, a preferred cheese powder flavor is a high fat cheese powder flavor of the approximate composition of the CheezTang flavor product described above. For fruit flavored fillers, the flavor may principally be from dehydrated fruit powders and/or fruit concentrates.

In addition to solid cheese flavors, other like solid savory flavors can be employed. For example, egg powders, meat powders, vegetable powders and the like can be employed in some embodiments.

In some embodiments, the particle size of the undissolved solids is important to the final texture. The particle size may be determined organoleptically and in some embodiments is below the threshold at which graininess is perceived. Many materials form loose aggregates that break down in the mouth to sizes within these ranges and are acceptable according to the invention. In some embodiments, the filling includes undissolved flavor ingredients. It has been found to be important that when a filling includes undissolved flavor ingredients, such ingredients are of sufficiently small particle size to provide the proper mouthfeel, flavor release and texture consistent with the savory flavor. For example, the mouthfeel for cheese fillings should be smooth and creamy and the yield stress high enough for the product to stay in place both before and after any heat treatment such as baking. In some embodiments, a cheese filling will have a lubricous, slippery, smooth mouthfeel and a flavor release that endures until the palate is essentially clean. For such fillings, it may be undesirable for the flavor to be completely released during the dissolution in saliva of only the liquid phase, leaving an unflavored portion of undissolved solids in the mouth.

Microparticles

Fillings of the present invention may include microparticles. When included in a filling at suitable levels, microparticles contribute to a desirable texture of smooth particle gels, creamy texture and/or mouthfeel, and/or bake stability. In some embodiments, inclusion of particles in a desired amount and/or of a desired size may provide a filling with a desirable yield stress, resulting in a filling having minimal spread before, during, and after baking. In some embodiments, such desirable yield stress and accompanying minimal-spread properties of the filling is a result of microparticles in the liquid component forming a particle gel, or sol. The formation of such gel or sol may be related to the size and/or amount of the microparticles included in the formulation.

Suitable microparticles may include fibers, cellulose, denatured/insoluble protein, water insoluble food materials, or a combination thereof. In some embodiments, suitable microparticles may have a particle size of about 10 microns or less; about 8 microns or less; about 5 microns or less; or about 3 microns or less.

In some embodiments, microparticles may be prepared by any suitable means, including jet milling, bead milling, denaturation, or precipitation. Commercially available microparticles may include Avicel (microcrystalline cellulose) and Simplesse (whey protein). In some embodiments, commercially available microparticles may be redistributed using a high shear device such as a Breddo high shear mixer or homogenizer, in order to further redistribute microparticle ingredients and to further emulsify fat particles.

In some embodiments, the amount of microparticles in the liquid component in the filling may be important for achieving the desired bake stability and/or taste and texture characteristics. In some embodiments, a filling includes microparticles in an amount of about 1 wt % to about 30 wt % of the liquid component of the filling; about 1 wt % to about 28 wt % of the liquid component of the filling; about 2 wt % to about 25 wt % of the liquid component of the filling; about 3 wt % to about 25 wt % of the liquid component of the filling; about 4 wt % to about 22 wt % of the liquid component of the filling; about 5 wt % to about 20 wt % of the liquid component of the filling; about 6 wt % to about 18 wt % of the liquid component of the filling; about 7 wt % to about 16 wt % of the liquid component of the filling; about 8 wt % to about 14 wt % of the liquid component of the filling; about 9 wt % to about 12 wt % of the liquid component of the filling; about 1 wt % of the liquid component of the filling; about 2 wt % of the liquid component of the filling; about 3 wt % of the liquid component of the filling; about 4 wt % of the liquid component of the filling; about 5 wt % of the liquid component of the filling; about 6 wt % of the liquid component of the filling; about 7 wt % of the liquid component of the filling; about 8 wt % of the liquid component of the filling; about 9 wt % of the liquid component of the filling; about 10 wt % of the liquid component of the filling; about 11 wt % of the liquid component of the filling; about 12 wt % of the liquid component of the filling; about 13 wt % of the liquid component of the filling; about 14 wt % of the liquid component of the filling; about 15 wt % of the liquid component of the filling; about 16 wt % of the liquid component of the filling; about 17 wt % of the liquid component of the filling; about 18 wt % of the liquid component of the filling; about 19 wt % of the liquid component of the filling; about 20 wt % of the liquid component of the filling; about 22 wt % of the liquid component of the filling; about 25 wt % of the liquid component of the filling; about 26 wt % of the liquid component of the filling; about 28 wt % of the liquid component of the filling; or about 30 wt % of the liquid component of the filling.

As mentioned above, the amount of microparticles in the filling may be important for providing the desired yield stress and spread properties before, during, and after baking. The ratio of microparticles to moisture in the filling may be important for achieving the desired bake stability and/or taste and texture characteristics. In some embodiments, the filling includes a weight ratio of microparticles to moisture of about 1:80 to about 1:2; about 1:60 to about 1:2; about 1:60 to about 1:4; about 1:32 to about 1:2; about 1:30 to about 1:4; about 1:30; about 1:28; about 1:26; about 1:24; about 1:22; about 1:20; about 1:19; about 1:18; about 1:17; about 1:16; about 1:15; about 1:14; about 1:13; about 1:12; about 1:11; about 1:10; about 1:9; about 1:8; about 1:7; about 1:6; about 1:5; about 1:4; about 1:3; or about 1:2.

Preparation of the Filling

The process of the invention entails mixing the ingredients in a manner that provides a uniform blend having the noted desirable textural properties. Although low shear mixing may be employed, in some embodiments, the process involves a high shear mixing step which effectively homogenizes the product and/or redistributes the microparticles. In addition, the high shear mixing reduces the size of the oil droplets which are dispersed throughout the savory filler composition.

In some embodiments, the filling ingredients are mixed and the resulting mixture is passed through a homogenizer and/or a bead mill. Homogenization and/or micromilling may further break down any microparticle ingredients and/or fat particles, and may stabilize the filling emulsion. In some embodiments, the filling ingredients are mixed and heated, and the resulting mixture is passed through a homogenizer at 5000/500 psi. In some embodiments, the filling ingredients are mixed and heated, and the resulting mixture is passed through a bead mill such as a K8 bead mill from Buhler.

Baked Dough Product

In some embodiments, a filling of the present invention may be used to prepare a baked dough and filling composite product comprising at least one discrete region of a filling as described above and at least one discrete region of a baked dough. In some embodiments, the dough is baked to non-crisp texture. This enables the preparation of filled or topped baked goods soft pretzels, soft bread, soft cake and the like.

The doughs can be formed on any of the conventional equipment, including laminators, extruders, depositors, rotary formers, wire cutters, and the like. The filling of the invention can be applied onto or into a preformed dough piece in any manner suitable and the resulting composite can be baked or otherwise cooked, e.g., fried, extruder heated, or the like. The invention enables the baking of the dough to a non-crisp texture without degrading the filling to an extent that oil of liquid migrates to the baked dough to cause textural or color problems. The filling will also not adversely affect the texture of the baked good. The filling can also be added to a baked good after the dough has been partially or fully baked. Conventional baking apparatus can be employed.

The term “dough” as used in this context includes all formulations that the person skilled in the art would consider dough. In some embodiments, these formulations contain a starch component and at least sufficient water to hydrate the starch, both being employed in reasonable proportions. The starch component can be provided as whole grain or grain ground or refined to any desired degree. It can be supplied in the form of flour, e.g., from wheat, barley, corn, oats, rice, rye, treacle, and the like. Or the starch component can be supplied as a purified or mechanically refined or less than whole grain flour. In some embodiments, the dough may be a starchless dough. The water can comprise water itself or an aqueous liquid such as milk (whole, skim, homogenized, buttermilk, or soy), fruit or vegetable juice, and the like. Yeast or chemical leavenings are also typically present. Also typically, the dough will contain shortening in an amount suitable for achieving the textural characteristics desired for a given type of product. In addition, the dough may also contain humectants in order to reduce the water activities of baked dough to within about 0.2 water activity, more preferably within about 0.1 water activity, most preferably within about 0.05 water activity of fillers. All other conventional ingredients, typical for desired recipes, can be employed. The entire text of Manley, J. R.; Technology of Biscuits, Crackers and Cookies, Vols. 1 and 2, is incorporated herein by reference for its descriptions of conventional ingredients and processing.

In another aspect, the invention provides products as described above, packaged in sealed containers, e.g., of either rigid or flexible construction. In one embodiment, a flexible plastic tube is provided for squeezing the filling onto or into a cooked or raw food product for eating as is or after cooking. The process of packaging is not changed from what is typically known for products of like viscosity.

The following examples are provided to further illustrate and explain a preferred form of the invention and are not to be taken as limiting in any regard. Unless otherwise indicated, all parts and percentages are by weight.

### EXAMPLES

### Example 1

### Cheese Filling Using Microcrystalline Cellulose Through Homogenization

A cheese filling composition was prepared by mixing and heating the following ingredients (% by weight) to about 65° C. Then, the mixture was passed through the homogenizer at 5000/500 psi.

| Ingredients | % by Weight |
|---|---|
| Water | 25.00 |
| Glycerol | 8.5 |
| Microcrystalline cellulose | 3.5 |
| Cheese/cream powders | 28.0 |
| Maltodextrin | 24.24 |
| Tri-calcium phosphate | 4.5 |
| Emulsifying salts | 3.0 |
| Salt | 1.2 |
| Emulsifier | 0.5 |
| Lactic acid | 0.4 |
| Flavoring ingredients | 0.95 |
| Preservatives | 0.15 |
| Colors | 0.06 |
| Total | 100.00 |

Total Aw value = 0.758

### Example 2

### Cheese Filling Using Simplesse Through Homogenization

A cheese filling composition was prepared by mixing and heating the following ingredients (% by weight) to about 65° C. Then, the mixture was passed through the homogenizer at 5000/500 psi. The particle size distribution curve is bimodal with the median particle size (D50) of 0.57 um.

| Ingredients | % by Weight |
|---|---|
| Water | 25.00 |
| Glycerol | 8.5 |
| Simplesse (denatured WPC) | 4 |
| Cheese/cream powders | 28.0 |
| Maltodextrin | 23.29 |
| Tri-calcium phosphate | 4.5 |
| Emulsifying salts | 3.0 |
| Salt | 1.2 |
| Emulsifier | 0.5 |
| Konjac gum | 0.45 |
| Lactic acid | 0.4 |
| Flavoring ingredients | 0.95 |
| Preservatives | 0.15 |
| Colors | 0.06 |
| Total | 100.00 |

Total Aw value = 0.795

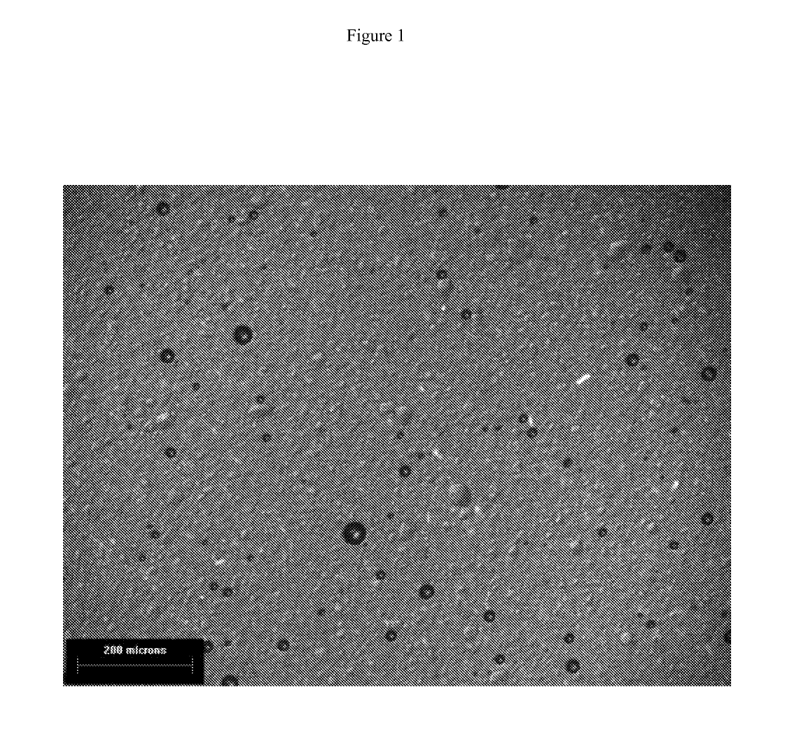

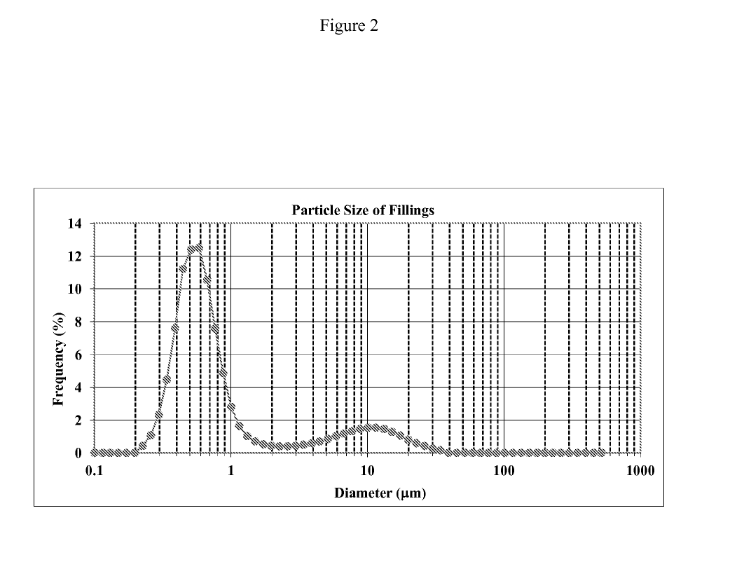

Microscopy images and particle size distribution of the filling are shown in FIGS. 1 and 2 respectively.

### Example 3

### Cheese Filling Using Wheat Fiber Through Micromilling

A cheese filling composition was prepared by mixing and heating the following ingredients (% by weight) to about 60° C. Then, the mixture was passed through the bead mill (K8 bead mill from Buhler) filled with 85% of 1.5 mm ceramic beads rotated at 1200 rpm. The flow rate was about 145 g/min.

| Ingredients | % by Weight |
|---|---|
| Water | 25.00 |
| Glycerol | 8.5 |
| White wheat fiber | 2.0 |
| Cheese/cream powders | 26.0 |
| Maltodextrin | 27.14 |
| Tri-calcium phosphate | 4.5 |
| Emulsifying salts | 3.0 |
| Salt | 1.5 |
| Emulsifier | 0.5 |
| Lactic acid | 0.6 |
| Flavoring ingredients | 1.05 |
| Preservatives | 0.15 |
| Colors | 0.06 |
| Total | 100.00 |

Total Aw value = 0.778

### Example 4

### Cheese Filling Using Microcrystalline Cellulose Through Homogenization

A cheese filling composition was prepared by mixing and heating the following ingredients (% by weight) to about 65° C. Then, the mixture was passed through the homogenizer at 5000/500 psi.

| Ingredients | % by Weight |
|---|---|
| Low fat cream cheese | 40.00 |
| Glycerol | 8.5 |
| Microcrystalline cellulose | 4.0 |
| Maltodextrin | 40.09 |
| Tri-calcium phosphate | 4.68 |
| Salt | 1.18 |
| Emulsifier | 0.5 |
| Lactic acid | 0.4 |
| Flavoring ingredients | 0.50 |
| Preservatives | 0.15 |
| Total | 100.00 |

Total Aw value = 0.772

### Example 5

### Chocolate Filling Using Microcrystalline Cellulose Through Homogenization

A chocolate filling composition was prepared by mixing and heating the following ingredients (% by weight) to about 65° C. Then, the mixture was passed through the homogenizer at 5000/500 psi.

| Ingredients | % by Weight |
|---|---|
| Water | 18.00 |
| Glycerol | 11.50 |
| Microcrystalline Cellulose | 3.50 |
| Cocoa Powder | 4.50 |
| Maltodextrin | 27.33 |
| Fat/Oil | 8.0 |
| Sweeteners | 18.00 |
| Non-fat Dried Milk | 8.0 |
| Emulsifier | 0.5 |
| Preservatives | 0.10 |
| Flavoring Ingredients | 0.37 |
| Methocel gum | 0.20 |
| Total | 100.00 |

Total Aw value = 0.70

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

The claims directed to the method of the present invention should not be limited to the performance of their steps in the order written except where expressly stated, and one skilled in the art can readily appreciate that the steps may be varied and still remain within the spirit and scope of the present invention.

We claim:

1. A bake stable filling comprising:
(a) a liquid component; and
(b) microparticles having a particle size of less than about 8 microns;
wherein the liquid component includes microparticles in an amount of about 1 wt % to about 30 wt % of the liquid component.

2. The filling of claim 1, wherein the liquid component includes microparticles in an amount of about 2 wt % to about 25 wt % of the liquid component.

3. The filling of claim 1, wherein the filling includes a ratio of microparticles to moisture of about 1:60 to about 1:4.

4. The filling of claim 1, wherein the microparticles comprise fibers, cellulose, protein, water insoluble food materials, or a combination thereof.

5. The filling of claim 1, wherein the microparticles comprise microcrystalline cellulose, whey protein, or a combination thereof.

6. The filling of claim 1, wherein the filling includes the liquid component in an amount of about 20 wt % to about 50 wt % of the filling.

7. The filling of claim 1, wherein the filling has a water activity of about 0.5 to about 0.86.

8. The filling of claim 1, wherein the liquid component comprises a polyhydric alcohol.

9. The filling of claim 1, wherein the filling exhibits substantially no filling spread in a radial direction beyond an original sample size when about 20 c.c. of the filler is placed on filter paper and exposed to a temperature of about 150° C. for about 10 minutes.

10. The filling of claim 1, wherein the filling exhibits a spread of less than about 1 cm in a radial direction beyond an outer edge of an original sample when about 20 c.c. of the filler is placed on filter paper and exposed to a temperature of about 150° C. for about 10 minutes.

11. The filling of claim 1, wherein the filling includes less than 30 wt % fat.

12. The filling of claim 1, wherein the filling has a shelf life of at least about 3 months.

13. The filling of claim 1, wherein the filling contains no starch.

14. The filling of claim 1, further comprising lipids, insoluble solids, soluble solids, or a combination thereof.

15. A composite product comprising the filling of claim 1 and a baked good.

16. An intermediate moisture filling comprising:
(a) a liquid component including water and at least one polyhydric alcohol; and
(b) microparticles having a particle size less than about 8 microns wherein the filling is bake stable and has a water activity of about 0.5 to about 0.85.

17. The filling of claim 16, wherein the liquid component includes microparticles in an amount of about 1 wt % to about 30 wt % of the liquid component.

18. The filling of claim 16, wherein the liquid component includes microparticles in an amount of about 2 wt % to about 25 wt % of the liquid component.

19. The filling of claim 16, wherein the filling includes a ratio of microparticles to moisture of about 1:60 to about 1:4.

20. The filling of claim 16, wherein the microparticles comprise fibers, cellulose, protein, water insoluble food materials, or a combination thereof.

21. The filling of claim 16, wherein the microparticles comprise microcrystalline cellulose, whey protein, or a combination thereof.

22. The filling of claim 16, wherein the filling includes the liquid component in an amount of about 20 wt % to about 50 wt % of the filling.

23. The filling of claim 16, wherein the filling exhibits substantially no filling spread in a radial direction beyond an original sample size when about 20 c.c. of the filler is placed on filter paper and exposed to a temperature of about 150° C. for about 10 minutes.

24. The filling of claim 16, wherein the filling exhibits a spread of less than about 1 cm in a radial direction beyond an outer edge of an original sample when about 20 c.c. of the filler is placed on filter paper and exposed to a temperature of about 150° C. for about 10 minutes.

25. The filling of claim 16, wherein the filling includes less than 30 wt % fat.

26. The filling of claim 16, wherein the filling has a shelf life of at least about 3 months.

27. The filling of claim 16, wherein the filling contains no starch.

28. The filling of claim 16, further comprising lipids, insoluble solids, soluble solids, or a combination thereof.

29. A composite product comprising the filling of claim 16 and a baked good.

30. A method of preparing a bake stable filling comprising:
(a) providing ingredients for a liquid component;
(b) providing microparticles having a particle size of less than about 8 microns;
(c) mixing the ingredients for the liquid component and the microparticles using a high shear device to provide a homogenous blend, wherein the liquid component includes microparticles in an amount of about 1 wt % to about 30 wt % of the liquid component.

31. The method of claim 30, further comprising passing the blend through a bead mill.

32. The method of claim 30, further comprising passing the blend through a homogenizer.

33. The method of claim 30, wherein the homogenous blend further comprises lipids, insoluble solids, soluble solids; or combinations thereof.

34. The method of claim 30, wherein the liquid component includes microparticles in an amount of about 2 wt % to about 25 wt % of the liquid component.

35. The method of claim 30, wherein the filling includes a ratio of microparticles to moisture of about 1:60 to about 1:4.

36. The method of claim 30, wherein the microparticles comprise fibers, cellulose, protein, water insoluble food materials, or a combination thereof.

37. The method of claim 30, wherein the microparticles comprise microcrystalline cellulose, whey protein, or a combination thereof.

38. The method of claim 30, wherein the filling includes the liquid component in an amount of about 20 wt % to about 50 wt % of the filling.

39. The method of claim 30, wherein the filling has a water activity of about 0.5 to about 0.86.

40. The method of claim 30, wherein the liquid component comprises a polyhydric alcohol.

41. The method of claim 30, wherein the filling exhibits substantially no filling spread in a radial direction beyond an original sample size when about 20 c.c. of the filler is placed on filter paper and exposed to a temperature of about 150° C. for about 10 minutes.

42. The method of claim 30, wherein the filling exhibits a spread of less than about 1 cm in a radial direction beyond an outer edge of an original sample when about 20 c.c. of the filler is placed on filter paper and exposed to a temperature of about 150° C. for about 10 minutes.

43. The method of claim 30, wherein the filling includes less than 30 wt % fat.

44. The method of claim 30, wherein the filling has a shelf life of at least about 3 months.
